(19) United States
(12) Patent Application Publication
(10) Pub. No.: US 2014/0020081 A1
(43) Pub. Date: Jan. 16, 2014

(54) Portable Token Device

(71) Applicants: Jiang Zhang, San Diego, CA (US); Richard O. Farley, San Diego, CA (US); Gang Ding, San Diego, CA (US); Patrik N. Lundqvist, Encinitas, CA (US)

(72) Inventors: Jiang Zhang, San Diego, CA (US); Richard O. Farley, San Diego, CA (US); Gang Ding, San Diego, CA (US); Patrik N. Lundqvist, Encinitas, CA (US)

(73) Assignee: QUALCOMM Incorporated, San Diego, CA (US)

(21) Appl. No.: 13/550,402

(22) Filed: Jul. 16, 2012

(51) Int. Cl. H04W 12/08

(52) U.S. Cl. CPC H04W 12/08
USPC 726/9

(57) ABSTRACT

Disclosed is a portable token device that may be used to assist a user in generating a PIN at one device and to then pass the PIN to another device such that the two devices can securely communicate with one another. The portable token device may include: an interface; and a processor. The processor may execute operations including: determining if a close proximity coupling through the interface to a first device has occurred; transmitting a PIN request to the first device; and obtaining a PIN. Further, the processor may determine if a close proximity coupling through the interface to a second device has occurred. If so, the processor may command transmitting the PIN to the second device. The second device may perform device registration with the first device based upon the received PIN.

### BACKGROUND

1. Field

The present invention relates generally to a portable token device that may be used to assist a user in generating a PIN at one device and to then pass the PIN to another device such that the two devices can securely communicate with one another.

2. Relevant Background

There are many different ways to set up secure wireless communication between two devices. For example, to connect two WiFi devices, a password/key may be set-up on one device (e.g., a router) and the same password/key may be typed in on another device (e.g., a laptop computer) such that they can securely communicate with one another. However, for other types of devices, there may be no keyboard to enter a password/key. For example, in a Wireless Home Digital Interface (WHDI) environment, a button press sequence may be used to generate a personal identification number (PIN) to securely have two home devices register with each other and to exchange a registration key with each other. Unfortunately, this button press sequence method requires users to remember and input a long button sequence, which may be difficult and may not be user-friendly.

A further problem is that many types of wireless devices do not have keyboards, buttons, or any type of input means to input PINs, passwords, keys, etc. This makes it very difficult for users to securely connect these types of wireless devices.

### SUMMARY

Aspects of the invention may relate to an apparatus and method for a portable token device that may be used to assist a user in generating a PIN at one device and to then pass the PIN to another device such that the two devices can securely communicate with one another. The portable token device may include: an interface; and a processor. The processor may execute operations including: determining if a close proximity coupling through the interface to a first device has occurred; transmitting a PIN request to the first device; and obtaining a PIN. Further, the processor may determine if a close proximity coupling through the interface to a second device has occurred. If so, the processor may command transmitting the PIN to the second device. The second device may perform device registration with the first device based upon the received PIN.

### BRIEF DESCRIPTION OF THE DRAWINGS

FIG. 1 is block diagram of a system in which aspects of the invention related to a portable token device may be practiced

FIG. 2 is a flow diagram illustrating a process implemented by the portable token device.

FIG. 3 is a diagram illustrating particular examples of the use of the portable token device.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

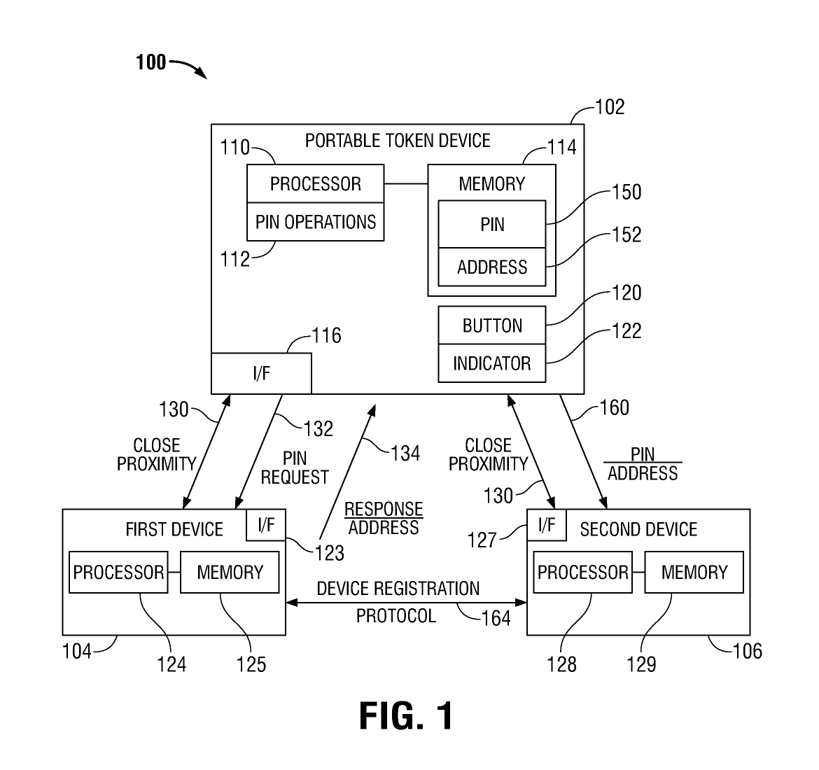

With reference to FIG. 1, FIG. 1 is block diagram of a system 100 in which aspects of the invention may be practiced. In particular, system 100 illustrates a portable token device 102 that may be used to assist a user in generating a personal identification number (PIN) at a first device 104 and to then pass the PIN to a second device 106 such that the two devices (e.g., first device 104 and second device 106) can securely communicate with one another. In particular, aspects of the invention relate to a portable token device 102 that allows first device 104 and second device 106 to authenticate one another and register with one another, based upon a PIN, such that they can securely communicate with one another.

Portable token device 102 may include a processor 110, a memory 114, and an interface (I/F) 116. Further, as will be described, portable token device 102 may include other features such as a button 120 and an indicator 122.

In one aspect, processor 110 may be configured to execute a PIN operations program 112 (e.g., received from and stored in memory 114) that generates a PIN to be shared between the first device 104 and the second device 106 that allows the second device 106 to authenticate itself and register with first device 104 such that they can securely communicate with one another and perform device registration protocol so that they can interact with one another. These PIN operations will be hereinafter described. To begin with, processor 110 executes a first operation to determine whether close proximity coupling 130 between portable token device 102 to first device 104 through I/F 116 has occurred. If close proximity coupling has occurred, processor 110 causes the transmission of a PIN request 132 through I/F 116 to first device 104. As will be described, based upon a response 134 from the first device 104, processor 110 may obtain a PIN.

Based upon the PIN request 132, first device 104 may transmit response 134, which may include a pre-configured PIN, a random PIN, or a random seed, to the portable token device 102. Optionally, the first device's 104 device address 152 may also be included in the response 134. In one aspect, processor 110 may directly use the pre-configured PIN or the random PIN received via the response 134 by the first device 104. In another aspect, based upon a received random seed from the first device 104 and one or more secrets shared between the portable token device 102 and the first device 104, processor 110 may generate a derived PIN. The PIN 150, such as, the derived PIN, may be stored in memory 114. The secret shared between the portable token device 102 and the first device 104 may be generated by the portable token device 102, the first device 104, or both. It could also be generated by a 3^{rd} party and set into both the portable token device 102 and the first device 104. Further, in one embodiment, PIN 150 may be a pre-configured PIN or a random PIN and will hereinafter be referred to as PIN 150. The address 152 of the first device 104 may also be stored in memory 114.

It should be appreciated that, as an example, based upon the shared secret and the random seed in the response 134, the derived PIN may be generated and known by both the portable token device 102 and the first device 104 without the first device 104 having to transmit the derived PIN itself. This is just one example of generating the PIN 150 and other methods may also be utilized. Further, although the term PIN is utilized it should be appreciated that any identifier may be used as the PIN 150, including pre-configured PINs, random PINs, keys, passwords, etc., which may be numerical and/or alphanumerical, and may be utilized as authentication and/or authorization identifiers between the first device 104 and the second device 106. Additionally, in one embodiment, address 152 may be a media access control (MAC) address, and will be hereinafter addressed as MAC address 152. However, it should be appreciated that other types of address method may be utilized.

Next, processor 110 of portable token device 102 may execute an operation to determine if close proximity 130 coupling through I/F 116 has occurred with second device 106. If so, processor 110 may command that PIN 150 and MAC address 152 be transmitted through I/F 116 and via link 160 to second device 106.

It should be appreciated that first device 104 may include a processor 124, a memory 125, and an interface 123, as well as other elements to perform functionality associated with first device 104. For example, interface 123 may receive PIN request 132 and transmit response 134 under the control of processor 124 to portable token device 102. Based upon the receipt of PIN request 132, when portable token device 102 and first device 104 are in close proximity, processor 124 may determine whether to transmit a pre-configured PIN, a random PIN or a random seed via response 134 to portable token device 102. Similarly, second device 106 may include a processor 128, a memory 129, and an interface 127, as well as other elements to perform functionality associated with second device 106. For example, I/F 127 may receive PIN and MAC address in message 160 from the portable token device 102 and under the control of processor 128 may perform device registration protocol 164 to register with first device 104 such that the first and second device 104 and 106 can verify if they are authorized to register with each other and consequently they can securely communicate with one another. As will be described in more detail later, first and second devices 104 and 106 may be a wide variety of different types of devices that perform various types of functions.

Based upon the PIN 150 received by second device 106, second device 106 under the control of processor 128 may perform device registration protocol 164 to register with first device 104 such that the first and second device 104 and 106 can securely communicate with one another and be linked to one another via their respective interfaces 123 and 127. Second device 106 may authenticate itself to first device 104 through the device registration protocol 164, based upon the PIN 150, known by first device 104, and that was transferred by portable token device 102 to second device 106. In particular, first device 104 under the control of processor 124 may verify if the second device 106 is authorized to register with the first device 104 based upon the PIN 150. Also, in one embodiment, as to authorization, first device 104 may utilize verification data derived from the PIN. Device registration protocol 164 based upon MAC addresses and other data is well known in the art.

In one aspect, close proximity coupling 130 may include close proximity wireless coupling via I/F 116 and corresponding I/Fs 123 and 127 of the first and second devices 104 and 106. In this aspect, portable token device 102 may touch or may get very close to the first and second devices 104 and 106 in order to implement close proximity wireless coupling. As an example, close proximity wireless coupling may be near field communication (NFC) coupling. Other types of close wireless coupling may include: BLUETOOTH, ZIGBEE, etc.

As another example, close proximity coupling 130 may include wired coupling with a portable token device 102 that is physically coupled to the first and second devices 104 and 106 via mating physical interfaces. An example of this, universal serial bus (USB) coupling may be used, in which the I/F 116 of the portable token device 102 is a USB interface and the first and second devices 104 and 106 similarly include USB ports or interfaces 123 and 127 for physically connecting with portable token device 102. It should be appreciated that a wide variety of different mating physical interfaces may be used to form a physical or wired connection between portable token device 102 and the first and second devices 104 and 106.

Further, in one aspect, as an example, portable token device 102 may include a button 120. Button 120 may be pushed by a user to transmit PIN request 132 to first device 104 and afterwards to transmit PIN 150 and MAC address 152 to second device 106. Also, an indicator 122 may be used to alert a user that portable token device 102 has successfully communicated with the first device 104. For example, the indicator 122 may alert a user that the PIN has been obtained in association with the first device 104. Further, indicator 122 may be used to alert the user that portable token device 102 has successfully communicated with the second device 106 such that the PIN 150 has been transmitted to the second device. Different types of indicators may be used to show this to users. As an example, indicator 122 may be a sound device to generate a sound (e.g., a buzzing or beeping sound) or indicator 122 may be a lighting device (e.g., an LED) to generate a light to indicate to a user that these events have occurred. The light may be white or colored and may be timed or flashing, etc. It should be appreciated that buttons and indicators are optional implementations on the portable token device 102.

Additionally, in one aspect, memory 114 of portable token device 102 may be used to temporarily store the PIN 150 and the MAC address 152 as it is being delivered from the first device 104 to the second device 106. This may be to enhance the security features of the portable token device 102. As an example, processor 110 may delete PIN 150 and MAC address 152 from memory 114 after a pre-determined period of time (e.g., after 5 or 10 minutes) or after the PIN 150 and random address 152 are delivered one or more times (e.g., to second, third, fourth devices, etc.). The length of the pre-determined time and the number of times that the PIN 150 and MAC address 152 may be delivered may be configurable and may be selected for the portable token device 102.

As one example, portable token device 102 may be used with first and second non-portable devices 104 and 106. Non-portable devices generally refer to devices that although they may be fixed or they may be moveable, they generally reside at one location. Examples of non-portable devices may include home devices (e.g., TVs, CDs, DVD players, set-top boxes, stereos, kitchen appliances, personal computers, etc.), energy monitoring devices, heating devices, security devices, machine-to-machine (M2M) devices, medical devices, or any type of device that is not easily portable. Obviously, there is a wide variety of non-portable devices that may wirelessly communicate with one another and this list is not exhaustive.

In particular, portable and non-portable wireless devices, such as, first and second devices 104 and 106, often do not include input mechanisms (e.g., keyboards) to input names, PINs, passwords, keys, etc., to authenticate and register with one another. Portable token device 102 may be used to assist a user in generating a PIN 150 at a first device 104 and to then pass the PIN 150 to another second device 106 such that the two devices (e.g., first device 104 and second device 106) can verify if they are authorized to register with each other and consequently securely communicate with one another. In particular, by passing the PIN 150, portable token device 102 allows first device 104 and second device 106 to authenticate one another and register with one another, based upon the PIN, such that they can be linked and securely communicate with one another. This can be accomplished without requiring a user to input names, PINs, keys, passwords, etc.

Therefore, in the example of the portable token device 102, there may be no keyboard, key pad, display device, etc. This is because these elements are not needed. The only components of the portable token device that are utilized may be: a processor 110, a memory 114 and an interface 116. Further, a button 120 and an indicator 122 may also be utilized (or not) by the portable token device 102, if desired, dependent upon design considerations. Accordingly, aspects of the invention provide benefits in that the portable token device 102 requires very little in terms of electronic components. For example, keyboards, key pads, display devices, etc, are not required or used. In essence, all that is required for portable token device 102 may be a processor, a memory and an interface. Accordingly, portable token device 102 may be a very simple and low cost device to be manufactured and utilized.

Additionally, it should be appreciated that because first and second non-portable devices 104 and 106 often do not include input mechanisms (e.g., keyboards, key pads, display devices) to input names, passwords, PINs, keys, etc., portable token device 102 makes it very easy to put first and second devices 104 and 106 in communication with one another without having to remember or type in these items.

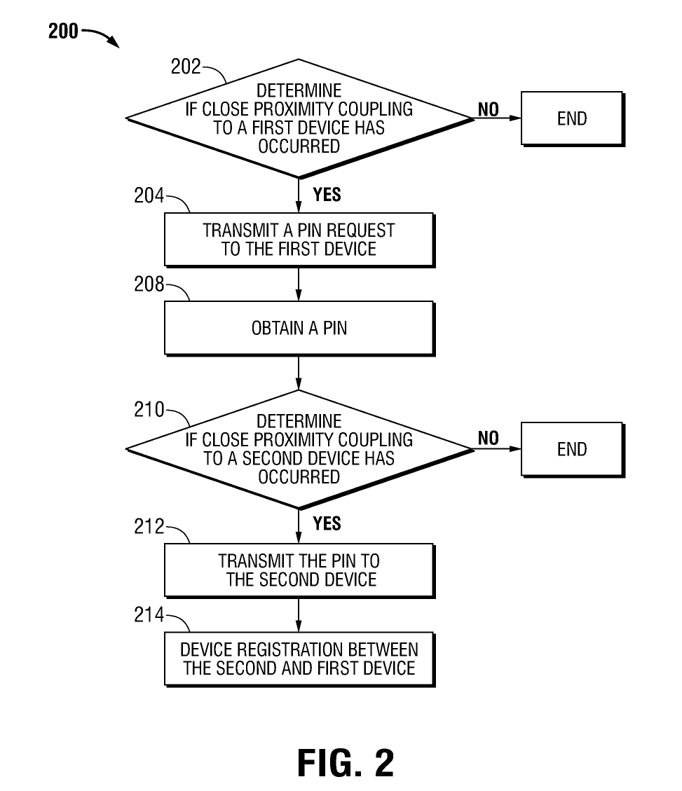

With brief additional reference to FIG. 2, FIG. 2 shows a flow diagram illustrating a process 200 for implementing a token assisted communication protocol by portable token device 102. At decision block 202, portable token device 102 may determine whether close proximity coupling with a first device 104 has occurred. If not, the process ends (or the process can be repeated periodically). However, if close proximity coupling has occurred, then a PIN request may be transmitted to the first device 104 (block 204). Next, portable token device 102 may obtain a PIN (block 208), as previously described in detail. Possible ways in which first device 104 determines a pre-configured PIN, a random PIN, or a random seed to be included in the response 134, could be defined based on the use case. As an example, if there is a pre-configured PIN set, then the pre-configured PIN could be sent; if there is a pre-shared secret between the first device 104 and the portable token device 102, a random seed can be used; or, a random PIN can be used. If the random seed is received, both the processor of the portable token device and the first device may generate the same derived PIN using the random seed and the shared secrets.

Next, at decision block 210, portable token device 102 determines whether close proximity coupling has occurred with a second device 106. If not, the process ends (or the process can be repeated periodically). However, if close proximity coupling has occurred with the second device 106, then portable token device 102 transmits the PIN to the second device 106 (block 212) and device registration between the second and first device 106 and 104 may occur (block 214), as previously described.

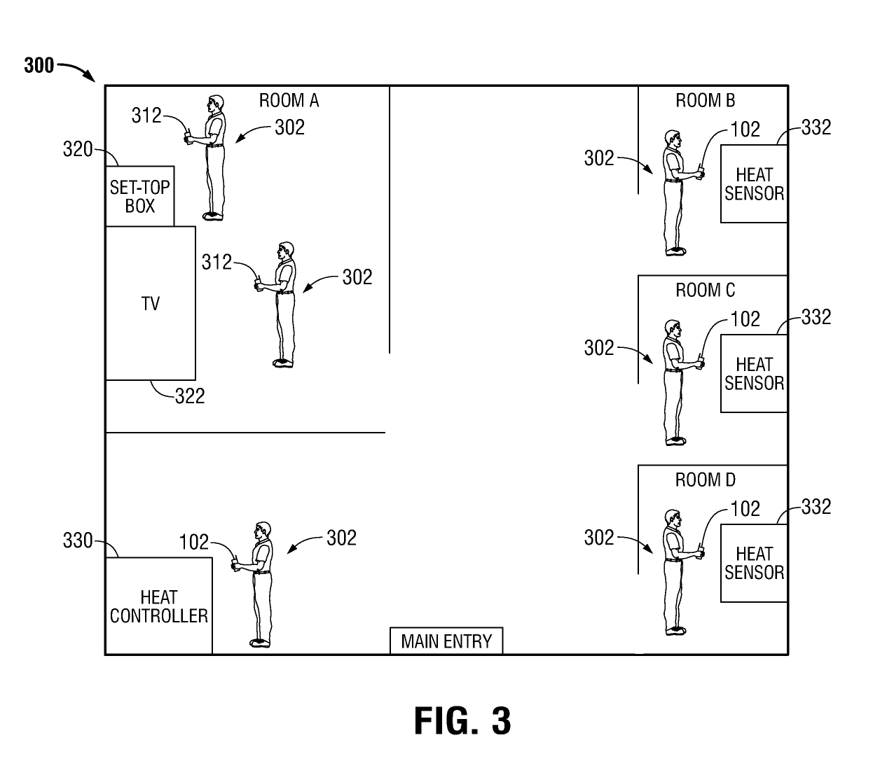

With additional reference to FIG. 3, particular examples of the use of portable token device 102 will be illustrated. For example, in a housing or building structure 300, a user 302, in Room A, may want to begin a device registration process to securely connect and wirelessly link two devices for interaction with each other. In this example, the portable token device 102 may be a remote control 312 and the first device 104 may be a set-top box 320 and the second device 106 may be a television (TV) 322. It should be appreciated that, in this example, the components and functionality of the previously-described portable token device 102 are integrated into remote control 312. The previously-described functionality of portable token device 102 likewise applies in this remote control 312 example and reference can be made back to FIG. 1.

In this example, in Room A, user 302 may first bring the remote control 312 to set-top box 320. Wireless coupling may be accomplished by close proximity wireless coupling 130 (e.g., via NFC coupling), in which user 302 may touch set-top box 320 with remote control 312. Further, user 302 may also press a button 120 on remote control 312 to enable the PIN request 132.

Assuming that the set-top box 320 and the remote control 312 already have a shared secret for the PIN derivation, once set-top box 320 detects remote control 312 through NFC coupling, and receives the PIN request 132, set-top box 320 may generate a random seed and may send the random seed to remote control 312 along with its MAC address, as well as other information. As previously described, remote control 312 may generate the derived PIN 150 based upon the received random seed and the secret shared with the set-top box 312 and may store this PIN 150 and the MAC address 152 locally in memory 114. The PIN 150 may be for one-time use and may only be valid for a short period of time (e.g., 5-10 minutes). After that, remote control 312 may discard it.

After remote control 312 has generated PIN 150, user 312 may take the remote control 312 to a second device, such as TV 322. The user may also press a button 120 on remote control 312 to start transmitting the PIN 150 to the TV 322. Once TV 322 detects the remote control 312 through NFC, TV 322 may acquire the PIN 150 and MAC address 152 to initiate device registration protocol 164 with set-top box 320 using the address 152. In this way, by passing the PIN 150 and MAC address 152, remote control 312 allows set-top box 320 and TV 322 to start secure device registration communication with one another and verify authorization with one another, such that they can be registered with each other and securely communicate with one another to enable secure TV content transmission. This may be accomplished by the portable token device enhancements without requiring a user to input names, PINs, keys, passwords, etc.

In particular, it should be appreciated that PIN 150 may be used as an authorization token by TV 322 to prove that this device registration with set-top box 320 is approved by the user. As an example, within a home network, normally only a family member may physically access the two devices within a short time period (e.g., 5-10 minutes). Optionally, TV 322 may also request the user's confirmation before initiating the device registration protocol. For example, set-top box 320 information (e.g., device type and name) may be displayed to the user on TV 322 for confirmation by an appropriate button on the remote control 312 being pressed.

In another example, a user 302 may first bring the portable token device 102 to a heat controller 330. Wireless coupling may be accomplished by close proximity wireless coupling 130 (e.g., via NFC coupling), in which user 302 may touch heat controller 330 with portable token device 102. Further, user 302 may also press a button 120 on portable token device 102 to enable the PIN request 132.

Once heat controller 330 detects portable token device 102 through NFC coupling, and receives the PIN request 132, heat controller 330 may generate a random seed and may send the random seed to portable token device 102 along with its MAC address, as well as other information. As previously described, portable token device 102 may generate a PIN 150 based upon the received random seed and a secret (shared with the heat controller 330) and may store this PIN 150 and MAC address 152 locally in memory 114. The PIN 150 may be for one-time use and may only be valid for a short period of time (e.g., 5-10 minutes). After that, portable token device 102 may discard it.

After portable token device 102 has generated PIN 150, user 312 may take the remote control 312 to a second device, such as heat sensor 332, in another area of the house 300, e.g., Room B. The user may also press a button 120 on portable token device 102 to start transmitting the PIN 150 to the heat sensor 332. Once heat sensor 332 detects the portable token device 102 through NFC, heat sensor 332 may acquire the PIN 150 and MAC address 152 to initiate device registration protocol 164 with heat controller 330 using the address 152. In this way, by passing the PIN 150 and MAC address 152, portable token device 102 allows heat controller 330 and heat sensor 332 to verify authorization with one another and securely register with one another, such that they can securely communicate with one another as to heating functionality. This may be accomplished without requiring a user to input names, PINs, keys, passwords, etc. Further, portable token device 102 may also be utilized in the same fashion to verify authorization and register other heat sensors 332 (e.g., in Rooms C and D) for heating functionality. Accordingly, portable token device 102 may be utilized to authorize and register multiple devices.

It should be appreciated that the previously described, set-top box, TV, heat controller, heat sensors, etc., are merely examples. Examples of other non-portable devices may include home devices (e.g., TVs, CDs, DVD players, set-top boxes, stereos, kitchen appliances, personal computers, etc.), energy monitoring devices, heating devices, security devices, machine-to-machine (M2M) devices, medical devices, or any type of device that may not be easily portable. Obviously, there is a wide variety of non-portable devices, such as M2M devices, that may wirelessly communicate with one another and this list is not exhaustive.

As previously described, wireless devices (portable and non-portable), often do not include input mechanisms (e.g., keyboards) to input names, PINs, passwords, keys, etc., to authenticate and register with one another. Portable token device 102 may be used to assist a user in generating a PIN at a first device and to then pass the PIN to another second device such that the two devices can securely communicate with one another. In particular, by passing the PIN, portable token device 102 allows a first device, a second device, as well as other multiple devices, to verify authorization of one another and register with one another such that they can be linked and securely communicate with one another. This can be accomplished without requiring a user to input names, PINs, keys, passwords, etc. Advantageously, as previously described, this methodology may be used by devices that do not have buttons or keyboards to input PINs, passwords, keys names, etc. Further, these implementations also improve the user's experience by not requiring the user to remember any PIN or button sequence. These methods may also be widely used by M2M devices, as many M2M devices do not have any PIN insertion mechanisms. Also, it should be appreciated that the aspects of the portable token device 102 may be implemented in other devices, such as, remote controls, M2M devices, mobile computers, mobile devices, personal digital assistants, wireless phones, wireless devices, cell phones, smart phones, tablets, laptop computers, or any type of portable computing device.

It should be appreciated that aspects of the invention previously described may be implemented in conjunction with the execution of instructions by processor 110 of portable token device 102, as well as the processors 124 and 128 of the first and second devices 104 and 106, and/or other devices. Particularly, circuitry of the portable token device and the first and second devices, including but not limited to processors, may operate under the control of a program, routine, or the execution of instructions to execute methods or processes in accordance with embodiments of the invention. For example, such a program may be implemented in firmware or software (e.g. stored in memory and/or other locations) and may be implemented by processors and/or other circuitry of the portable token device and the first and second devices. Further, it should be appreciated that the terms processor, microprocessor, circuitry, controller, etc., refer to any type of logic or circuitry capable of executing logic, commands, instructions, software, firmware, functionality, etc

It should be appreciated that when the portable token device and the other devices are mobile or wireless devices that they may communicate via one or more wireless communication links through a wireless network that are based on or otherwise support any suitable wireless communication technology. For example, in some aspects the portable token device and the other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, CDMA, TDMA, OFDM, OFDMA, WiMAX, and Wi-Fi. Similarly, a wireless device may support or otherwise use one or more of a variety of corresponding modulation or multiplexing schemes. A wireless device may thus include appropriate components (e.g., air interfaces) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a mobile wireless device may therefore wirelessly communicate with other mobile devices, cell phones, other wired and wireless computers, Internet web-sites, etc.

The techniques described herein can be used for various wireless communication systems such as Code Division Multiple Access (CDMA), Time division multiple access (TDMA), Frequency Division Multiple Access (FDMA), Orthogonal Frequency-Division Multiple Access (OFDMA), Single Carrier FDMA (SC-FDMA) and other systems. The terms “system” and “network” are often used interchangeably. A CDMA system can implement a radio technology such as Universal Terrestrial Radio Access (UTRA), CDMA2000, etc. UTRA includes Wideband-CDMA (W-CDMA) and other variants of CDMA. CDMA2000 covers Interim Standard (IS)-2000, IS-95 and IS-856 standards. A TDMA system can implement a radio technology such as Global System for Mobile Communications (GSM). An OFDMA system can implement a radio technology such as Evolved Universal Terrestrial Radio Access; (Evolved UTRA or E-UTRA), Ultra Mobile Broadband (UMB), Institute of Electrical and Electronics Engineers (IEEE) 802.11 (Wi-Fi), IEEE 802.16 (WiMAX), IEEE 802.20, Flash-OFDM®, etc. Universal Terrestrial Radio Access (UTRA) and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). CDMA2000 and UMB are described in documents from an organization named “3rd Generation Partnership Project 2” (3GPP2).

The teachings herein may be incorporated into (e.g., implemented within or performed by) a variety of apparatuses (e.g., devices). For example, one or more aspects taught herein may be incorporated into a phone (e.g., a cellular phone), a personal data assistant (“PDA”), a tablet, a mobile computer, a laptop computer, a tablet, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a server, a point-of-sale device, an entertainment device, a set-top box, or any other suitable device. These devices may have different power and data requirements

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A portable token device comprising:
an interface; and
a processor to execute operations including:
determining if a close proximity coupling through the interface to a first device has occurred;
transmitting a PIN request to the first device;
obtaining a PIN;
determining if a close proximity coupling through the interface to a second device has occurred; and
transmitting the PIN to the second device.

2. The portable token device of claim 1, wherein the PIN is received from the first device.

3. The portable token device of claim 1, wherein, the PIN is generated based upon a random seed from the first device and a secret shared between the portable token device and the first device.

4. The portable token device of claim 1, wherein, based upon the PIN received by the second device, the second device performs device registration with the first device.

5. The portable token device of claim 1, wherein, close proximity coupling comprises close proximity wireless coupling.

6. The portable token device of claim 5, wherein, close proximity wireless coupling comprises near field communication (NFC) coupling.

7. The portable token device of claim 1, wherein, close proximity coupling comprises wired coupling.

8. The portable token device of claim 1, further comprising a button, wherein the button is pushed by a user to transmit the PIN request to the first device and to transmit the PIN to the second device.

9. The portable token device of claim 1, wherein, the PIN is a random PIN.

10. The portable token device of claim 1, further comprising a memory to store the PIN.

11. The portable token device of claim 10, wherein the processor deletes the PIN from the memory after a pre-determined period of time or after the PIN has been transmitted for a pre-determined number of times.

12. The portable token device of claim 1, further comprising an indicator, the indicator to alert a user that the PIN has been obtained at the first device and that the PIN has been transmitted to the second device.

13. A method to pass a PIN from a first device to a second device comprising:
determining if a close proximity coupling to the first device has occurred;
transmitting a PIN request to the first device;
obtaining a PIN;
determining if a close proximity coupling to the second device has occurred; and
transmitting the PIN to the second device.

14. The method of claim 13, wherein the PIN is received from the first device.

15. The method of claim 13, wherein, the PIN is generated based upon a random seed from the first device and a secret shared between the portable token device and the first device.

16. The method of claim 13, wherein, based upon the PIN received by the second device, the second device performs device registration with the first device.

17. The method of claim 13, wherein, close proximity coupling comprises close proximity wireless coupling.

18. The method of claim 17, wherein, close proximity wireless coupling comprises near field communication (NFC) coupling.

19. The method of claim 13, wherein, close proximity coupling comprises wired coupling.

20. The method of claim 13, further comprising:
transmitting the PIN request to the first device based upon a received push button signal; and
transmitting the PIN to the second device based upon a received push button signal.

21. The method of claim 13, wherein, the PIN is a random PIN.

22. The method of claim 13, further comprising, alerting a user that the PIN has been obtained at the first device and that the PIN has been transmitted to the second device.

23. A computer program product executed at a portable token device comprising:
a computer-readable medium comprising code for:
determining if a close proximity coupling to the first device has occurred;
transmitting a PIN request to the first device;
obtaining a PIN;
determining if a close proximity coupling to the second device has occurred; and
transmitting the PIN to the second device.

24. The computer program product of claim 22, wherein the PIN is received from the first device.

25. The computer program product of claim 23, wherein, the PIN is generated based upon a random seed from the first device and a secret shared between the portable token device and the first device.

26. The computer program product of claim 23, wherein, based upon the PIN received by the second device, the second device performs device registration with the first device.

27. The computer program product of claim 23, wherein, close proximity coupling comprises close proximity wireless coupling.

28. The computer program product of claim 27, wherein, close proximity wireless coupling comprises near field communication (NFC) coupling.

29. The computer program product of claim 28, wherein, close proximity coupling comprises wired coupling.

30. The computer program product of claim 23, further comprising code for:
commanding the PIN request be transmitted to the first device based upon a received push button signal; and
commanding the PIN be transmitted to the second device based upon a received push button signal.

31. The computer program product of claim 23, wherein, the PIN is a random PIN.

32. The computer program product of claim 23, further comprising code for alerting a user that the PIN has been obtained at the first device and that the PIN has been transmitted to the second device.

33. A portable token device comprising:
means for determining if a close proximity coupling to a first device has occurred;
means for transmitting a PIN request to the first device;
means for obtaining a PIN;
means for determining if a close proximity coupling to a second device has occurred; and
means for transmitting the PIN to the second device.

34. The portable token device of claim 33, wherein the PIN is received from the first device.

35. The portable token device of claim 33, wherein, the PIN is generated based upon a random seed from the first device and a secret shared between the portable token device and the first device.

36. The portable token device of claim 33, wherein, based upon the PIN received by the second device, the second device performs device registration with the first device.

37. The portable token device of claim 33, wherein, close proximity coupling comprises close proximity wireless coupling.

38. The portable token device of claim 37, wherein, close proximity wireless coupling comprises near field communication (NFC) coupling.

39. The portable token device of claim 33, wherein, close proximity coupling comprises wired coupling.

40. The portable token device of claim 33, wherein, the PIN is a random PIN.

41. A first device comprising:
an interface; and
a processor to execute operations including:
receiving a PIN request through the interface from a portable token device when the portable token device and the first device are coupled in close proximity; and
transmitting a response to the portable token device.

42. The first device of claim 41, wherein, the response includes a PIN.

43. The first device of claim 42, wherein, the PIN is a random PIN.

44. The first device of claim 41, wherein, the response includes a random seed.

45. The first device of claim 41, wherein, based upon the response, the portable token device obtains a PIN that is transmitted to a second device, and based upon the PIN received by the second device, the second device performs device registration with the first device.

46. The first device of claim 45, wherein the processor executes a further operation to verify the authorization of the second device, based upon the PIN received from the second device or verification data derived from the PIN, during device registration.

47. The first device of claim 41, wherein, close proximity coupling comprises close proximity wireless coupling.

48. The first device of claim 47, wherein, close proximity wireless coupling comprises near field communication (NFC) coupling.

49. The first device of claim 41, wherein, the first device does not include input mechanisms for the receipt of PINs.

50. A method to transmit a response to a portable token device from a first device comprising:
receiving a PIN request from the portable token device when the portable token device and the first device are coupled in close proximity; and
transmitting the response to the portable token device.

51. The method of claim 50, wherein, the response includes a PIN.

52. The method of claim 51, wherein, the PIN is a random PIN.

53. The method of claim 50, wherein, the response includes a random seed.

54. The method of claim 50, wherein, based upon the response, the portable token device obtains a PIN that is transmitted to a second device, and based upon the PIN received by the second device, the second device performs device registration with the first device

55. The method of claim 54, further comprising, verifying authorization of the second device based upon the PIN received from the second device or verification data derived from the PIN during device registration.

56. The method of claim 50, wherein, close proximity coupling comprises close proximity wireless coupling.

57. The method of claim 56, wherein, close proximity wireless coupling comprises near field communication (NFC) coupling.

58. A computer program product executed at a first device comprising:
a computer-readable medium comprising code for:
receiving a PIN request from a portable token device when the portable token device and the first device are coupled in close proximity; and
transmitting a response to the portable token device.

59. The computer program product of claim 58, wherein, the response includes a PIN.

60. The computer program product of claim 59, wherein, the PIN is a random PIN.

61. The computer program product of claim 58, wherein, the response includes a random seed.

62. The computer program product of claim 58, wherein, based upon the response, the portable token device obtains a PIN that is transmitted to a second device, and based upon the PIN received by the second device, the second device performs device registration with the first device

63. The computer program product of claim 62, further comprising code for verifying authorization of the second device based upon the PIN received from the second device or verification data derived from the PIN during device registration.

64. The computer program product of claim 58, wherein, close proximity coupling comprises close proximity wireless coupling.

65. The computer program product of claim 64, wherein, close proximity wireless coupling comprises near field communication (NFC) coupling.

66. A first device comprising:
means for receiving a PIN request from a portable token device when the portable token device and the first device are coupled in close proximity; and
means for transmitting a response to the portable token device.

67. The first device of claim 66, wherein, the response includes a PIN.

68. The first device of claim 67, wherein, the PIN is a random PIN.

69. The first device of claim 66, wherein, the response includes a random seed.

70. The first device of claim 66, wherein, based upon the response, the portable token device obtains a PIN that is transmitted to a second device, and based upon the PIN received by the second device, the second device performs device registration with the first device

71. The first device of claim 70, further comprising, means for verifying the authorization of the second device based upon the PIN received from the second device or verification data derived from the PIN during device registration.

72. The first device of claim 66, wherein, close proximity coupling comprises means for close proximity wireless coupling.

73. The first device of claim 72, wherein, the means for close proximity wireless coupling comprises near field communication (NFC) coupling.
